(19) United States
(12) Patent Application Publication
(10) Pub. No.: US 2021/0110078 A1
(43) Pub. Date: Apr. 15, 2021

(54) METHOD AND SYSTEM FOR DETERMINING THE PANELIZATION OF A WALL

(71) Applicant: Consulting Engineers, Corp., Reston, VA (US)

(72) Inventor: Maharaj Jalla, Great Falls, VA (US)

(73) Assignee: Consulting Engineers, Corp., Reston, VA (US)

(21) Appl. No.: 16/695,406

(22) Filed: Nov. 26, 2019

Related U.S. Application Data
(60) Provisional application No. 62/912,690, filed on Oct. 9, 2019.

(51) Int. Cl. G06F 30/13

(52) U.S. Cl. CPC G06F 30/13; G06F 2111/02

(57) ABSTRACT

A computer method for panelising the structural member of a wall, comprising; receiving, an architectural drawing of a floor plan; identifying, each of the features of the floor plan, wherein the features are the walls and apertures; calculating, the true width of the walls, wherein the true width is that of the framing members of the wall; generating, a drawing of the centreline of all the features of the floor plan; rendering, a drawing of the frame members of the floor plan; calculating, a maximum set of dimensions for a panel; and generating, a set of panels, wherein it is determined if a panel is greater than the maximum set of dimensions for a panel, the panel is segmented into a series of panels which are within the maximum set of dimensions for a panel.

### CROSS-REFERENCE TO RELATED APPLICATIONS

This application is a continuation-in-part (and claims the benefit of priority under 35 USC 120) of U.S. provisional application No. 62/291,2688 filed Oct. 9, 2019, U.S. provisional application No. 62/912,690 filed Oct. 9, 2019. The disclosure of the prior applications is considered part of (and is incorporated by reference in) the disclosure of this application.

### BACKGROUND

This Disclosure relates generally to building construction and in particular, to the method, computer program, or computer system for using the center line of a surface to develop the layout and features of the surface.

The study of architectural drawing has typically been done manually by the user of the software. To study the architectural drawing and to identify different elements in the drawings which are relevant to the software. The user has to manually go through all the features of the architectural drawings and manually convert them to the 2D drawings or 3D models. Architectural drawings typically show all the building features which are required for the construction of the building. It shows the different room locations, sizes of the room, arrangements of different rooms. It also shows the wall finishing material used for the exterior surface and interior surface. It is a tremendous and tedious process to convert this manually to the software format.

However, this process is necessary in any design or detailing software. The task of inputting the walls per the architectural drawing is necessary to calculate accurate engineering design or drawings reports. Manual method of the inputting of the layout of building has disadvantages like time-consuming task, lead to an error by incorrect inputs. Even still, many times the walls of a building are preassembled and delivered to the job site. Without extensive calculations and determinations is incredibly difficult to determine the perfect size to make each wall panel to ship and install these panels.

In process of building construction of cold formed steel and lumber material, the traditional construction method of stick framing is popular where each wall framing member is erected as a stick. To increase the speed of construction, a panelized construction method is used in which walls are constructed as panel which consist of specific length and height is created and used in building construction.

Therefore, it is desired for a program that is able to provide the unique feature of wall panelization in which the wall as per Architectural layout is panelized based on the transportation limit of the construction material. The unique way of wall panelization in Automation software has several advantages over traditional method. The present invention provides for a system and method to automatically convert the content of the architectural drawings to determine the exact size and measurements of each wall panel to product a perfect model of the drawings.

### SUMMARY

In a first embodiment, the present invention is a computer method for panelising the structural member of a wall, comprising: receiving, by one or more processors, an architectural drawing of a floor plan; identifying, by one or more processors, each of the features of the floor plan, wherein the features are the walls and apertures; calculating, by one or more processors, the true width of the walls, wherein the true width is that of the framing members of the wall; generating, by one or more processors, a drawing of the centreline of all the features of the floor plan; rendering, by one or more processors, a drawing of the frame members of the floor plan; calculating, by one or more processors, a maximum set of dimensions for a panel; and generating, by one or more processors, a set of panels, wherein it is determined if a panel is greater than the maximum set of dimensions for a panel, the panel is segmented into a series of panels which are within the maximum set of dimensions for a panel.

In a second embodiment, the present invention is a computer program product for panelising the structural member of a wall, the computer program product comprising a computer readable storage medium having program instructions embodied therewith, the program instructions executable by a computing device to cause the computing device to: program instructions to receive an architectural drawing of a floor plan; program instructions to identify each of the features of the floor plan, wherein the features are the walls and apertures; program instructions to calculate the true width of the walls, wherein the true width is that of the framing members of the wall; program instructions to generate a drawing of the centreline of all the features of the floor plan; program instructions to render a drawing of the frame members of the floor plan; program instructions to calculate a maximum set of dimensions for a panel; and program instructions to generate a set of panels, wherein it is determined if a panel is greater than the maximum set of dimensions for a panel, the panel is segmented into a series of panels which are within the maximum set of dimensions for a panel.

In a third embodiment, the present invention is a system comprising: a CPU, a computer readable memory and a computer readable storage medium associated with a computing device; program instructions to receive an architectural drawing of a floor plan; program instructions to identify each of the features of the floor plan, wherein the features are the walls and apertures; program instructions to calculate the true width of the walls, wherein the true width is that of the framing members of the wall; program instructions to generate a drawing of the centreline of all the features of the floor plan; program instructions to render a drawing of the frame members of the floor plan; program instructions to calculate a maximum set of dimensions for a panel; and program instructions to generate a set of panels, wherein it is determined if a panel is greater than the maximum set of dimensions for a panel, the panel is segmented into a series of panels which are within the maximum set of dimensions for a panel.

### BRIEF DESCRIPTION OF THE DRAWINGS

Referring now to the drawings in which like reference numbers represent corresponding parts throughout:

FIG. 1 depicts a block diagram depicting a computing environment, in accordance with one embodiment of the present invention.

FIG. 2 depicts a block diagram depicting the internal and external components of the server and computing device of FIG. 1, in accordance with one embodiment of the present.

FIG. 3 depicts a cloud computing environment, in accordance with one embodiment of the present invention.

FIG. 4 depicts a flowchart of the operational steps of a method for calculating the required panels and panel construction to build the frame member drawing within the computing environment of FIG. 1, in accordance with one embodiment of the present invention.

FIG. 5 depict 2-Dimensional Architectural Floor Layouts for a building, in accordance with one embodiment of the present invention.

FIG. 6, depicts the center line drawing created after referring the architectural drawings shown in FIG. 5, in accordance with one embodiment of the present invention.

FIG. 7, depicts the 2-Dimensional Wall layout plan created in a design software using the centerline drawing from FIG. 6, in accordance with one embodiment of the present invention.

FIG. 8, depicts the 3-Dimensional floor plan with different panels identified, in accordance with one embodiment of the present invention.

FIG. 9, depicts the 2-Dimensional wall panel, in accordance with one embodiment of the present invention.

### DETAILED DESCRIPTION

The present invention provides a process of converting architectural drawing to a design or detailing software format through the use of center lines of the walls which are included in the architectural drawings. Typically, with design or detailing software the task of inputting walls into the building model based on the architectural drawing is necessary to calculate accurate engineering design or drawing reports. Manual method of the Input of the Layout of building has disadvantages like time-consuming task, lead to an error by incorrect inputs. The present invention provides a centerline approach to draw the centerline of the walls of any building layout in the architectural drawings and generate a drawing that is true to the framing members without any finishing materials. This framing drawing is then analyzed to determine the number of panels, the construction of these panels, and the like so that all the panels can be pre-manufactured and assembled and delivered to the job site.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

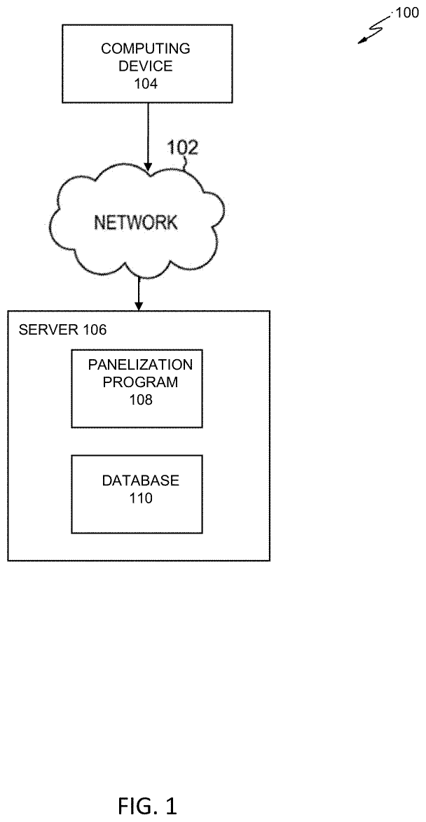

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, computing device 104, and server 106. Computing environment 100 may include additional servers, computers, or other devices not shown.

Network 102 may be a local area network (LAN), a wide area network (WAN) such as the Internet, any combination thereof, or any combination of connections and protocols that can support communications between computing device 104 and server 106 in accordance with embodiments of the invention. Network 102 may include wired, wireless, or fiber optic connections.

Computing device 104 may be a management server, a web server, or any other electronic device or computing system capable of processing program instructions and receiving and sending data. In other embodiments, computing device 104 may be a laptop computer, tablet computer, netbook computer, personal computer (PC), a desktop computer, or any programmable electronic device capable of communicating with patient computing device 104 via network 102. In other embodiments, computing device 104 may be a server computing system utilizing multiple computers as a server system, such as in a cloud computing environment. In one embodiment, computing device 104 represents a computing system utilizing clustered computers and components to act as a single pool of seamless resources. Computing device 104 may include components, as depicted and described in further detail with respect to FIG. 1.

Server 106 may be a management server, a web server, or any other electronic device or computing system capable of processing program instructions and receiving and sending data. In other embodiments server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment Panelization Program 108 and database 110 are located on server 106. Server 106 may include components, as depicted and described in further detail with respect to FIG. 1.

Panelization Program 108 has the unique feature of being able determine the number of panels required to be constructed to build the frame drawing, and also determine how to construct these panels so each panel is complete and easily attached to the adjacent panels. In the depicted embodiment, Panelization Program 108 utilizes network 102 to access the computing device 104 and to communicate with database 110. In one embodiment, Panelization Program 108 resides on computing device 104. In other embodiments, Panelization Program 108 may be located on another server or computing device, provided Panelization Program 108 has access to database 110.

Database 110 may be a repository that may be written to and/or read by Panelization Program 108. Information gathered from computing device 104 and the 1-dimensional, 2-dimensional, and 3-dimensional drawings and models as well as the requirements so that the materials and members are identified as conflicting or non-conflicting. In one embodiment, database 110 is a database management system (DBMS) used to allow the definition, creation, querying, update, and administration of a database(s). In the depicted embodiment, database 110 resides on computing device 104. In other embodiments, database 110 resides on another server, or another computing device, provided that database 110 is accessible to Panelization Program 108.

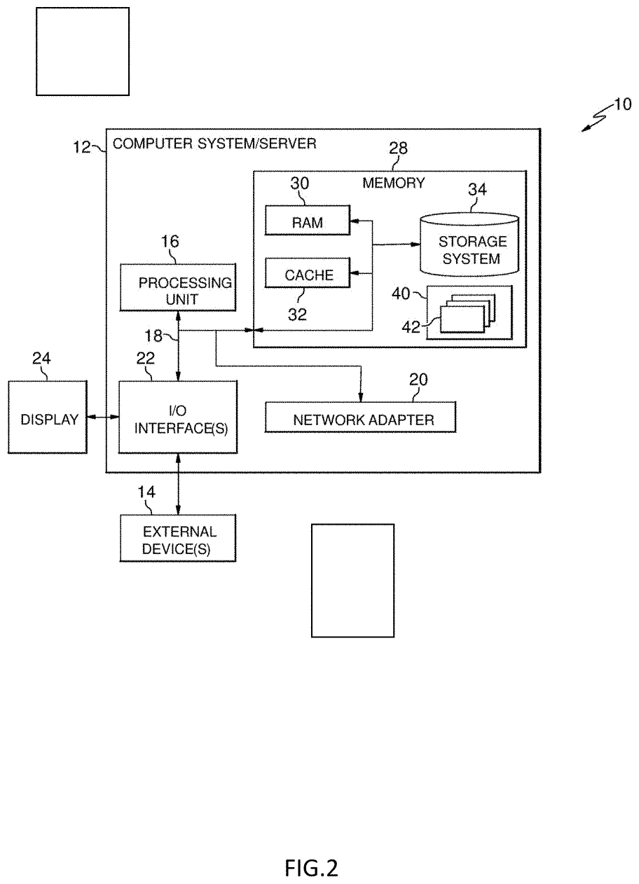

FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

FIG. 2, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

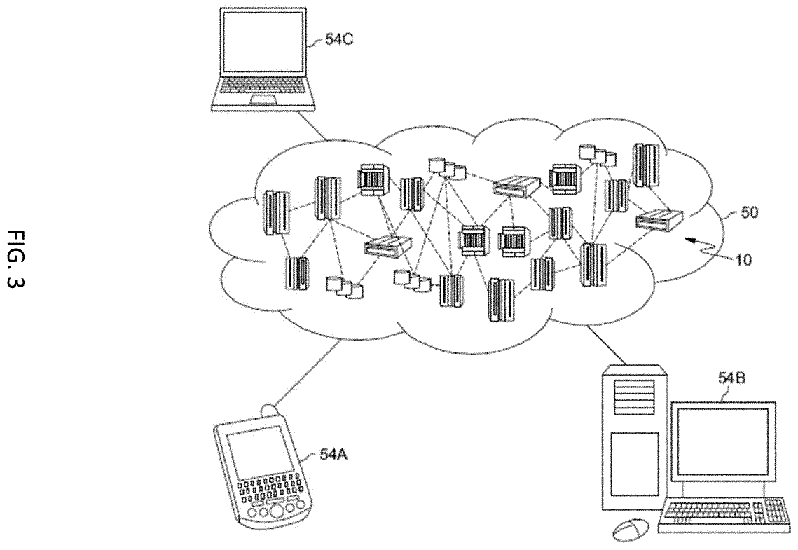

FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or additional computer systems may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

Referring back to FIG. 2, the Program/utility 40 may include one or more program modules 42 that generally carry out the functions and/or methodologies of embodiments of the invention as described herein. Specifically, the program modules 42 may monitor real-time parking facility camera data, receive vehicle identification information for a vehicle entering a parking facility, identify driver and vehicle information based on the vehicle identification information, identify open parking spaces based on the real-time parking facility camera data, determining attributes of the open parking spaces, score the open parking spaces based on the attributes, the vehicle information, and the driver information, select a particular open parking space based on the scoring, determine navigation directions to the selected parking space, and outputting navigation directions and information for the selected parking space, e.g., to a user device of the driver and/or to a vehicle interface system, such as a vehicle navigation system. Other functionalities of the program modules 42 are described further herein such that the program modules 42 are not limited to the functions described above. Moreover, it is noted that some of the modules 42 can be implemented within the infrastructure shown in FIGS. 1-3.

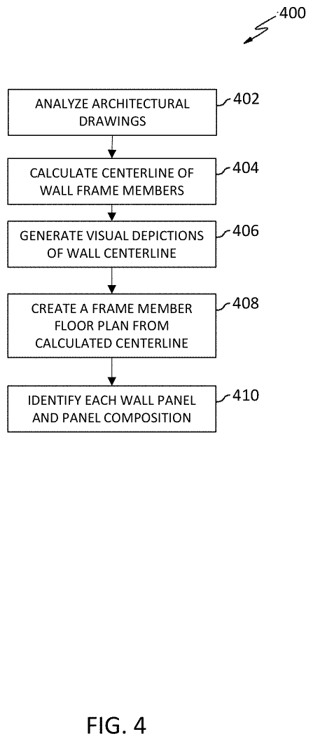

FIG. 4 depicts flowchart 400 depicting a method according to the present invention. The method(s) and associated process(es) are now discussed, over the course of the following paragraphs, in accordance with one embodiment of the present invention. The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

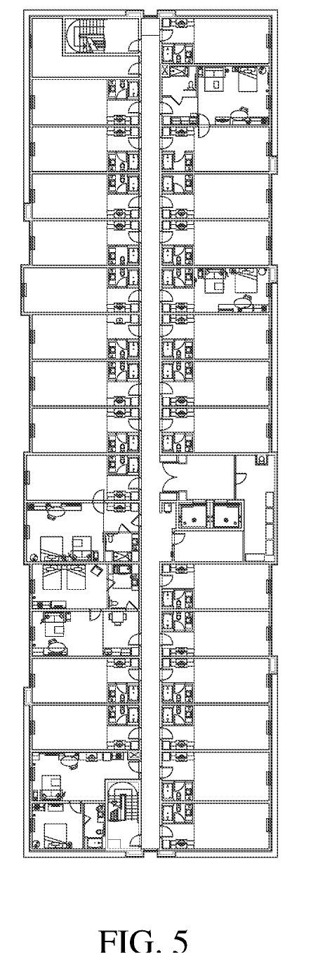

In step 402, the Panelization Program 108, analyzes architectural drawings to determine the real centerline of each wall within the architectural drawings. The Panelization Program 108 is able to determine the size and construction of each panel which is used to complete the building of the frame drawing. The unique features of the architectural drawings which are then used to locate the center lines for all of the walls, both interior and exterior. FIG. 5 depicted an illustration 500 of what an architectural drawing may look like. In an Architectural layout, the walls are shown with the finishing material on the exterior and the interior surfaces of the wall, but typically do not show the frame members of the wall. The framing members which are not created need to be identified and extracted to determine the correct center of the wall without any finishing materials for the conversion of the drawings to the design software. From the total wall width in the architectural drawings, the Panelization Program 108 is able to determine the actual framing member location in all of the walls of the drawings. This information allows the Panelization Program 108 to determine the true width of the wall. By analyzing the walls and determined the true with, the centerline of the wall is easily calculated. With this information, the Panelization Program 108 is able to analyze the walls and determine the location of any aperture (e.g. window, doorway, or the like) in the frame drawing.

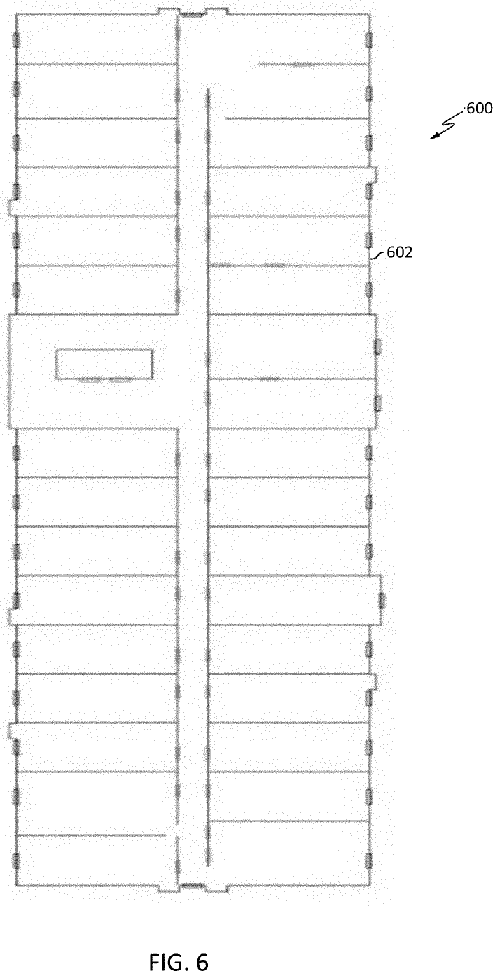

In step 404, the Panelization Program 108, calculates the centerline of all the identified walls. In the calculating the Panelization Program 108 generates an image 600, depicted in FIG. 6, of the true centerlines 602 for all of the walls within the drawing. In the depicted illustration, doors and windows are also identified, as these features are used to assist the Panelization Program 108 with determining the walls from the apertures and other features of the drawings. This illustration 600 shows the true distances from the center of the frame members to all over walls and is necessary for the calculation of the frame members. If this calculation is not performed, when calculating the number and dimensions of the frame members, all the dimensions would be incorrect by the thickness of the sheathing or finishing materials and would result in large amount of waste product being produced. In some embodiments, this illustration is created a separate layer from the architectural drawings. After marking the centerline of the walls, the openings in the particular floor are marked on the drawing. In one embodiment, the openings are marked as a closed polygon line. The openings or apertures may be created aby a separate layer specified by the software; this is typically the same layer as the centerlines.

The unique way of marking the center lines is to draw the center lines of the walls in a first layout. The openings are also drawn in the similar approach in a second layer. I then design software; the layers are converted into a standard predefined layer. The unique way of importing the center lines of the walls to develop the wall layout in the design software has several advantages over conventional method. One main advantage is the perfect replication of the floor plan and wall placement to complete remove the potential for errors when transferring the floor plan because of the miscalculation of finishing or sheathing material being incorporated into the structural measurements.

In step 406, the Panelization Program 108 generates the drawing of the center line of all the walls depicted in FIG. 6. In some embodiments, the completed centerline layers for all floors in the building are copied into a specified folder location. The Panelization Program 108 is able to start the importing of the layers and also add the relevant information about the particular floor. The centerline data may be associated with a datum for each floor in the building. Using this datum or location recognition software, the Panelization Program 108 is able to correctly line up each floor plan if a 3D model is to be created from the drawings, this would include also the structural floor depth and height of the floor. In some embodiments, the Panelization Program 108 is able to import other information that was preserved in various other layers or data, such as details of the surfaces of the floor plan sheathing material properties, finishing material properties, insulation materials, height of the walls, placement of various objects within the floor plan (e.g. electrical, HVAC, mechanical), and the like.

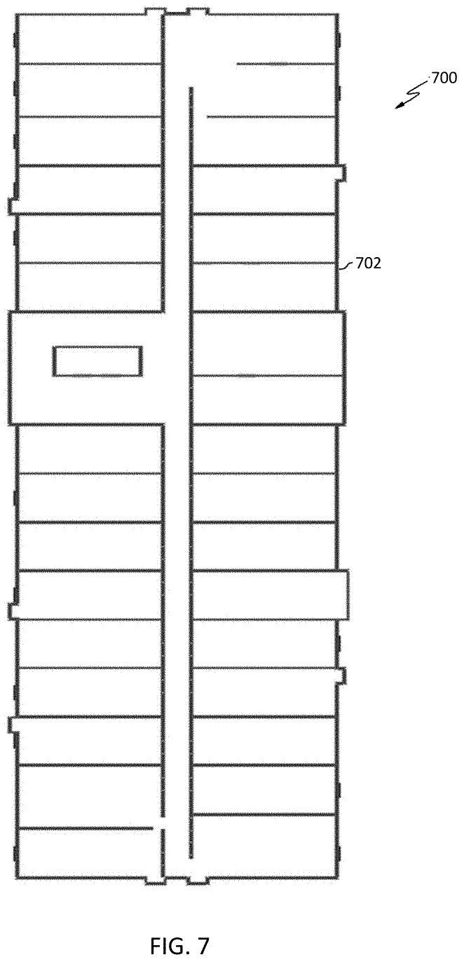

In step 408, Panelization Program 108, generates the drawings in the design software of the true size of the wall framing members. After the centerline layers are imported in the design software, the center lines of each walls are read by the design software and converted into the design software layer. The information related to the wall is transferred into the database of the design software, for example global position of the wall relative to a reference location or point, the relative position of wall with adjacent walls, and all other related information which can be identified by the software. After the data is transferred into the design software, the wall structural width is assigned, based on the previously collected data related to the wall thickness and the walls are created by the design software of the true width of the frame members. In some embodiments, the openings are also created as well and are identified in the drawing. Based on the number and type of layers which the features of the architectural drawings are exported into, the process may happen in parallel or in series based on the design software limitations. As shown in FIG. 7, the floor layout 700 is shown similar to FIG. 5, but this shows the true thickness of the framing members 702 and the proper dimensions of the wall the panels.

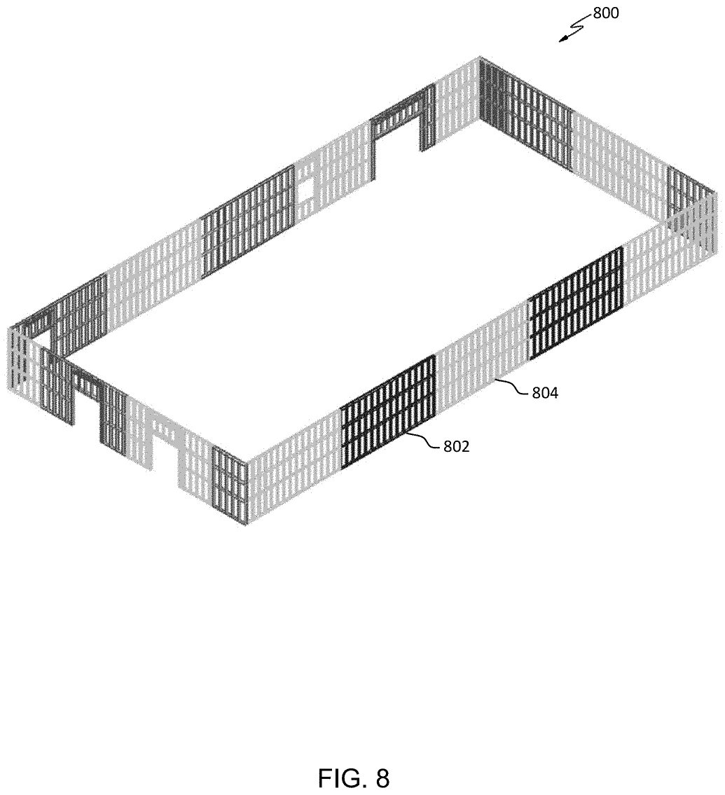

In step 410, the Panelization Program 108 identifies each wall panel and the composition of these wall panels. The Panelization Program 108 is able to, based on a set of limiters, determine how many panels need to be created to construct the building. As shown in FIG. 8, the building floor 800 consists of four sides, each side a panel. However, to build a panel that is so large would make transportation of the panel difficult or impossible. The limitations on the panel size may be based on the facility manufacturing the panels, the form of transportation, or the like. For example, the transportation limits are of two types, transportation length and transportation height. transportation limits are typically determined by the vehicle which transport the wall panels to the construction site from factory. When the wall panels or roof trusses, or floor trusses are assembled in the factory and transported to construction site, the dimensions of the walls, trusses have to be within transportation limit so when the wall panels, trusses are loaded in the vehicle it can fit inside the vehicle completely. If a wall is determined to exceed these limitations, the Panelization Program 108 creates panels that are within the limitations. Each panel or panel segment is created, wherein FIG. 8 each panel is identified in a different color or visual marker, for example panels 802 and 804.

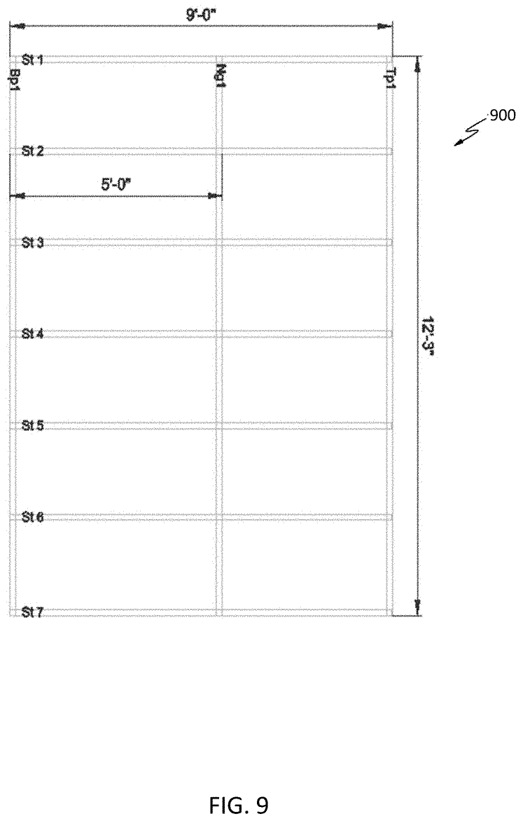

With the creation of the multi-panel wall, there is an issue that arises in terms of connecting these panels together. If the wall was constructed as a single panel, it would have the two end members complete the panel. However, with the breaking down of the wall into multiple panels, several panels would no longer have an end member, and thereby create another issue with the transportation and construction of the wall. The Panelization Program 108 is able to, once each panel is identified, is modify the panel design, so that each panel is designed to easily secure to the adjacent panels and have no effect on the overall dimensions of the wall. FIG. 9, depicts an image 900 of panel 802 where two end members ST1 and ST7 are used to structural reinforce the panel 802, but are designed in a way that the overall panel width does not increase. In additional embodiments, the panels can be created with the end members. Additionally, the Panelization Program 108 is able to take into consideration the apertures within the walls, so that the panels which are created do not interfere with these features of the wall, or that that panels result in a decrease in the overall strength of the building frame.

The present invention provides the advantage of being to optimize the sheathing requirements for a building to calculate as close to exact of an answer of the quantity of sheathing and the alterations to the sheathing during install and also maximum the use and placement of the sheathing to reduce was and time lost

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

1. A computer method for panelising the structural member of a wall, comprising:
receiving, by one or more processors, an architectural drawing of a floor plan;
isolating, by the one or more processors, walls of the floor plan, wherein the walls are distinguished from other elements of the floor plan;
identifying, by one or more processors, at least one centerlines of each wall;
calculating, by the one or more processors, a true width of the walls, wherein the true width is that of framing members of the wall;
manipulating, by the one or more processors, the architectural drawings of the floor plan to a framing member model, wherein the framing member model is populated with a plurality of framing members based on a predetermined building design;
segmenting, by the one or more processors, the framing member model into segments, wherein the segments are identified based on the predetermined building design;
converting, by one or more processors, the segments into completed panels; and
generating, by the one or more processors, an updated framing member model based on the panels and a rendering of the each of the panels.

2. (canceled)

3. (canceled)

4. The computer method of claim 1, further comprising, identifying, by the one or more processors, a set of apertures within the walls, and incorporating the location of the apertures in the segmenting of the panel.

5. (canceled)

6. (canceled)

7. The computer method of claim 1, further comprising, calculating, by the one or more processors, if each of the panels of the series of panels meet a set of shipping limitations.

8. A computer program product for panelising the structural member of a wall,
the computer program product comprising a computer readable storage medium having program instructions embodied therewith, the program instructions executable by a computing device to cause the computing device to:
program instructions to receive an architectural drawing of a floor plan;
program instructions to identify walls of the floor plan;
program instructions to extract the walls from the floor plan
program instructions to calculate at least one true center line of the walls;
program instructions to calculate the true width of the framing members based on the calculated true center line;
program instructions to generate a layer of the framing members over the floor plan
program instructions to generate a 3D model of the framing members, wherein the 3D model includes the plurality of individual framing members positioned based on a construction design;
program instructions to calculate a maximum set of dimensions for a panel;
program instructions to segment the wall into a set of panels, wherein it is determined if the wall is greater than the maximum set of dimensions for a panel, the wall is segmented into at least two panels, and the panels are segmented based on the features of the wall; and
program instructions to update the 3D model based on the segmentation of the wall into panels.

9. (canceled)

10. The computer program product of claim 8, further comprising, program instructions to generate a model, wherein the set of panels are distinguishable from one another.

11. (canceled)

12. (canceled)

13. (canceled)

14. The computer program product of claim 8, further comprising, program instructions to calculate if each panel of the series of panels meets a set of shipping limitations.

15. A system comprising:
a CPU, a computer readable memory and a computer readable storage medium associated with a computing device;
program instructions to receive an architectural drawing of a floor plan;
program instructions to isolate features of the floor plan related to walls of the floor plan;
program instructions to calculate center lines of the walls;
program instructions to calculate the true dimensions of the walls based on the calculated center lines;
program instructions to generate a 3D model of the walls, where individual vertical and horizontal framing members are generated;
program instructions to calculate a set of dimensions for a panel; and
program instructions to manipulate the 3D model into a set of panels, wherein each panel has end members and the set of panels are manipulated based on the inclusion of the end members to maintain the true dimensions of the walls.

16. (canceled)

17. (canceled)

18. The system of claim 15, further comprising, program instructions to identify a set of apertures within the walls, and incorporating the location of the apertures in the segmenting of the panel.

19. (canceled)

20. The system of claim 15, further comprising, program instructions to calculate if each panel of the series of panels meets a set of shipping limitations.

21. (canceled)

22. The method of claim 1, further comprising, generating, by at least one processor, a first layer of the true width of the framing members, and a second layer of the features of the wall.

23. The method of claim 22, further comprising, positioning, by the one or more processors, the first and second layer over the architectural drawing of the floor plan to properly position the framing members and features over the floor plan.

24. The method of claim 1, further comprising, creating, by the one or more processors, datums for each floor plan of a structure, wherein the datums include a depth of a floor and a height of the walls.

25. The method of claim 23, further comprising, manipulating, by the one or more processors, the first layer to include the positioning of the framing members to form the walls.

26. The method of claim 1, further comprising, manipulating, by the one or more processors, the segments of the wall based on a construction process for the segment.
